(19) United States
(12) Patent Application Publication
(10) Pub. No.: US 2005/0205553 A1
(43) Pub. Date: Sep. 22, 2005

(54) Coil design for magnetic pulse welding and forming

(75) Inventors: Wentao Cheng, Powell, OH (US); Prabhat Krishnaswamy, Columbus, OH (US)

Correspondence Address: RANDALL J. KNUTH P.C., 4921 DESOTO DRIVE, FORT WAYNE, IN, 46815, US

(73) Assignee: ENGINEERING MECHANICS CORPORATION OF COLUMBUS

(21) Appl. No.: 11/055,149

(22) Filed: Feb. 10, 2005

Related U.S. Application Data
(60) Provisional application No. 60/545,385, filed on Feb. 17, 2004.

(51) Int. Cl. B23K 13/01

(52) U.S. Cl. 219/603

(57) ABSTRACT

A magnetic pulse welding (MPW) or forming (MPF) device is provided having a split coil design, thereby facilitating the opening and closing thereof. As such, part/workpieces can be readily loaded and unloaded with respect thereto. This ability to easily load and unload parts is considered critical to the successful application of MPW technology to mass production environments. The open/split coil design includes a plurality of independent induction coil sections, allowing the device to be quickly opened/closed for loading/unloading of workpieces therewithin.

### CONTINUATION DATA

This application hereby claims the benefit under Title 35, United States Codes § 119(e) of any U.S. application Ser. No. 60/545,385 filed Feb. 17, 2004, and is hereby incorporated by reference.

### BACKGROUND OF THE INVENTION

1. Field of the Invention

The present invention relates to a magnetic pulse welding and forming device, and more particularly to a pulse welding and forming device having a split coil design, thereby allowing opening and closing of the device for workpiece insertion and removal.

2. Description of the Related Art

The magnetic pulse welding (MPW) or forming (MPF) process utilizes electromagnetic energy to create a metallurgical bond without melting the materials to be joined. First developed in the 1970s in both the US and the former Soviet Union (Epechurin, VP “Properties of bimetal joints produced by magnetic-pulse welding,” Welding Production, Vol. 21, No. 5. pp. 21-24, (1974); Brown, W F; Bandas, J and Olson, N T “Pulsed magnetic welding of breeder reactor fuel pin end closures,” Welding Journal, No. 6 pp 22-26, (1978)), the MPW process is based on well-established electromagnetic theory and is suitable for joining tubular structures. The process principle is illustrated in FIG. 1. Two tubular parts are configured to form a lap type joint. The basic requirement of the process is that the outer tube is electrically conductive and possesses certain amount of plastic deformation capability. The inner tube can be a different material, either conductive or non-conductive, in nature.

The passage of a high current discharge from the MPW power source through a specially designed coil and field shaper assembly creates an induction current (eddy current) in the conductive outer tube. Interactions of the two electromagnetic fields associated with the primary discharge current and the eddy current result in a repulsion force (the Lorenz force) between the coil and the outer tube. The magnitude of this repulsion force is approximately proportional to the square of the discharge current.

The MPW process is designed to create a repulsion force powerful enough to cause the outer tube impacting the inner tube at a velocity that is sufficiently high, in the range of several hundreds meters per second (Kojima, M; Tamaki, K; Suzuki, J; and Sasaki K “Flow stress, collision velocity and collision acceleration in electromagnetic welding,” Quarterly Journal of the Japan Welding Society, 7 (1) 75-81, (1989)), for localized deformation and subsequent bonding. Fundamentally, the MPW process follows the same physics principles as the electromagnetic forming process (Plum, M “Electromagnetic Forming”, Metals Handbook, volume 14, 9th edition, ASM, 645, (1995); Daehn, G S, Vohnout, V J and Datta, S “Hyperplastic forming: process potential and factors affecting formability,” Materials Research Society, Superplasticity—Current Status and Future Potential (USA), pp. 247-252, (2000); Daehn, G S “High Velocity Sheet Metal Forming: State of the Art and Prognosis for Advanced Commercialization.”) However, the MPW process may require a much higher repulsion force to generate sufficient velocity for bonding.

The MPW process is particularly useful in making a strong metallurgical bond between dissimilar materials such as Al to steel, a task that is generally impossible with traditional welding processes. The MPW technology will have broad commercial applications in a number of industries including automotive, aerospace, appliance, and electronic and telecommunication. The MPW technology is expected to have significant economic impact in assembling tubular structures in automotive and aerospace applications.

The technology will potentially revolutionize the assembly process of hydroformed tubular structures in next-generation energy-efficient automotive vehicles. It can become a critical, enabling materials joining technology to promote the hybrid automotive body structure design that uses both aluminum alloys and steels. Such designs would likely substantially reduce the weight of SUVs and improve vehicle performance at the same time. MPW may also enable joining of different materials such as titanium to superalloys for aerospace applications. In addition, MPW is ideal to replace certain brazing and soldering operations of tubes and electrical connectors that are widely used in automotive, aerospace, appliances, electronics and telecommunication. This would eliminate a number of environmental concerns associated with brazing such as energy consumption, use of hazardous chemicals, and costly recycling of lead-containing brazed parts.

Since the invention of the MPW process, the basic design of the induction coil has always been a closed electric loop. Similar to a solenoid in principle, the closed coil design provides a closed loop for passage of the discharged current around the tube. The looped path is considered to be necessary for the generation of the repulsion force for bonding. FIG. 2a shows a closed coil, and FIG. 2b illustrates the current flow in the coil. The welded or forming assembly can only be removed axially from the closed coil. Applications of MPW with closed coil design are described in U.S. Pat. Nos. 6,255,631; 5,966,813; 5,981,921 and 5,824,998.

The closed coil design has imposed a significant limitation on MPW technology. The limitation arises from the inability to join parts that form a closed loop. Similarly, assemblies in which the part moved by the magnetic field is smaller in diameter than other portions of the assembly required opening of the coil or tooling for removal after joining or forming. For example, in automotive applications, the shapes of hydroformed tubes generally are quite complex. Discussions with automotive companies revealed that only a small percentage of the hydroformed tubes can be physically inserted and removed axially along the axis of the coil during MPW operation. Therefore, the coil must be redesigned so that the weld head assembly can be quickly opened and closed to allow the loading and unloading of the hydroformed tubes.

Several attempts have been made to design and build a magnetic coil that could be opened and closed much like a clamshell utilizing conducting interfaces. All to date have met with limited success, not sufficient for production purposes. FIG. 3 illustrates the principle of such a coil design.

The open coil design of FIG. 3 employs a fully conducting interface that would essentially duplicate the behavior of the closed coil. The major exception would obviously be that the conducting interfaces would allow the coil to be opened for inserting complex parts for welding or forming. The largest drawback of this design is that the conducting interface is easily worn and destroyed during operation. Two major technical difficulties associated with the conducting interface design are that the contact needs to carry ˜1 mega-amp of current without excessive heating during the 100 microseconds that it takes to make the weld; and the contact at the conducting interface has to work ‘perfectly’ without any air gaps that could result in ‘arcing’ during operation. Also, the service life of such a contact has to be ˜100,000 welds for economic feasibility and hence the wear due to contacting interface has to be minimal since any air gap would lead to arcing during service. The trial of the coil design has indicated that it could not be used in the production environment. While the interface worked very successfully for about 100 trials, the wear in the contact surface increased thereafter leading to ‘arcing’ and other problems in performance.

U.S. Pat. No. 6,229,125 shows a potential open coil design. It consists of two coils positioned in tandem along the axis of the coils. However, the design does not utilize a magnetic field in the volume encircled by the coil inner surface, where the magnetic field is most intensified. Therefore, the optimal electrical efficiency of the overall system cannot be achieved by such design. Another attempt to open coil design can be found in U.S. patent application Ser. No. 10/249,188 (Pub No. U.S. 2003/0209536 A1). Multiple multi-turn solenoid coils are utilized in this design. Since coil segments are electrically connected in series, therefore the power input and magnetic field of the coil segments cannot be controlled independently.

What is needed in the art is a MPW or MPF device which can be quickly opened and closed to allow for loading and unloading of a workpiece and be able to have a service life of at least one hundred thousand welds for economic feasibility.

### SUMMARY OF THE INVENTION

The present invention provides a MPW or MPF device having an open/split coil design, thereby facilitating the opening and closing thereof. As such, parts/workpieces can be readily loaded and unloaded with respect thereto. This ability to easily load and unload parts is considered critical to the successful application of MPW technology to mass production environments.

An advantage of the present invention is that the open/split coil design allows the device to be quickly opened/closed for loading/unloading of workpieces therewithin.

Another advantage of the present invention is that the individual coil sections of the split coil design are both physically protected and electrically insulated from one another by the presence of an insulating layer mounted at the interface between them. The electrical power input of each coil section can be independently controlled. As a result of the presence of such an insulating layer, there is reduced mechanical wear of the coils, and arcing between such coils is prevented.

A further advantage of the present invention is that, while currents from the individual coil portions are kept separate from one another, currents within a given coil section or portion are uninterrupted and, when the sections are operatively located relative to each other, their currents together form a unidirectional flow path proximate the open workpiece zone created therewithin. This unidirectional current flow path permits the required magnetic excitation for successful magnetic pulse welding or forming to occur.

An added advantage of the present invention is that the openable design can potentially accommodate relatively complex weld part configurations, especially when considering that workpiece zone cross-sections that are other than circular in cross-section (e.g., polygonal) may potentially be employed. The advantage of independently controllable coil sections in terms of electrical power input is evident when joining parts with non-circular cross-sections. For example, when certain area of the parts need more intensified magnetic fields and higher magnetic forces, the power input of the corresponding and relevant coil section can be adjusted to higher level.

Another advantage of the present invention is the use of coil sections in this invention constructed of massive high-strength conductors. They are more easily manufactured and maintained than prior multi-turn solenoid coils.

An even yet additional advantage of the present invention is that the open/split coil design is amenable to mass production of MPW workpieces, while the presence of insulating interface material between the coil sections allows for the device to have a suitable service lifetime.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic, cut-away view illustrating the process principle of magnetic pulse welding (prior art);

FIG. 2a is a perspective view of the weld head assembly of a closed coil of a prior art version of an MPW device;

FIG. 2b is a schematic, sectional view of the prior art closed coil shown in FIG. 2a, illustrating the current flow in the coil;

FIG. 3 is a schematic, sectional view of an open coil design of the prior art having conductive interfaces to allow for coil opening; and

FIG. 4 is a schematic, sectional view of the open/split coil design of the magnetic pulse welding or forming device of the present invention.

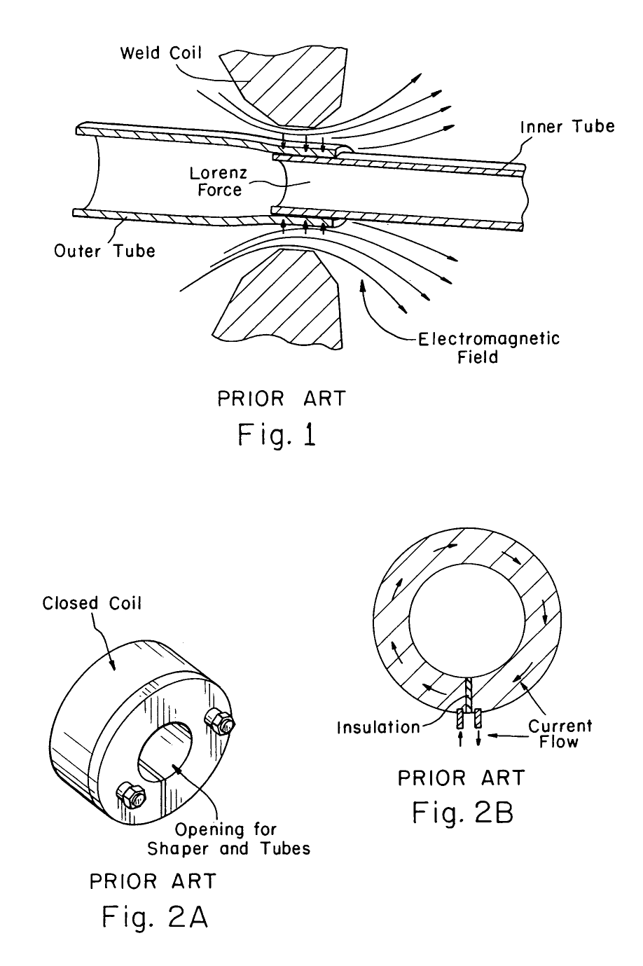

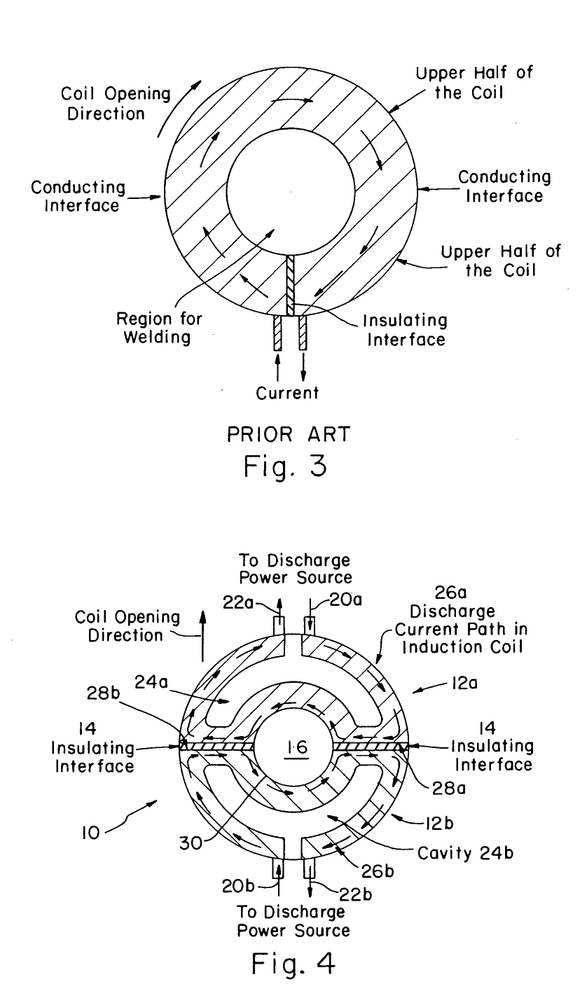

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

As seen in FIG. 4 the open (split) coil magnetic pulse welding or forming device 10 of the present invention includes a plurality of coil sections, indicated as coil sections 12A and 12B in the present embodiment; insulating interface 14; and workpiece receiving zone 16.

Coil sections 12a and 12b are selectably matingly faceable with respect to one another in such a manner so that they may be easily moved into and out of contact with one another. This ability to move relative to one another facilitates loading and unloading of a workpiece assembly (not shown) into and out of workpiece receiving zone 16. Like parts for coil sections 12a and 12b are numbered similarly with parts indicated with a “a” being associated with coil section 12a, and those labeled with a “b” being associated with coil section 12b. Accordingly, coil sections 12a, b include an induction coil member 12a, b; a discharge power source input 20a, b; a discharge power source output 22a, b; a coil cavity 24a, b; and a discharge current path 26a, b. The electrical power is supplied to coil section 12a through 20a and 22a; the electrical power is supplied to coil section 12b through 20b and 22b. The electrical power inputs to coil sections 12a and 12b are independent from each other. It is to be understood that, while two such coil sections 12a, b are indicated in FIG. 4, it is considered within the scope of the present invention that any number of coil sections 12 could potentially be employed, as long as the coil sections 12 are capable of operating together to provide an open coil MPW device 10 that is able to achieve the appropriate degree of magnetic excitation required to achieve magnetic pulse welding/forming therewith.

Each induction coil member 18a, b is configured to operate independently of the other such coil sections as each coil section 12a, b has its own input 20a, b and output 22a, b. By being separately connected to a discharge power source (not shown), it is possible for the mating sections 12a, b to be moved relative to one another and still retain their appropriate electrical connection for producing a magnetic field relative to such a section 12a, b. Each induction coil member 18a, b is advantageously formed of a highly conductive metal such as aluminum or copper and is formed so as to include a coil cavity 24a, b therewithin. Such a coil cavity 24a, b may be formed by machining of a solid coil member to form the appropriate coil cavity 24a, b therewithin. Alternatively, the induction coil member 18a, b could be molded and/or cast so as to directly form the appropriate cavity 24a, b therewithin. By creation of coil cavity 24a, b within induction coil member 18a, b and by providing a coil gap 25 between input 20a, b and output 22a, b, it is thereby possible to create the desired discharge current path 26a, b within such induction coil member 18a, b.

The insulating interface 14 is provided between each contacting set of section faces 28a, b. Such an insulating interface 14 reduces the opportunity for mechanical wear of the coil sections, thereby increasing the life of the coil sections 12a, b. Additionally, due to the insulating nature of the interface material, arcing between coil sections 12a, b upon contact thereof is prevented. An insulating interface layer 14 is attached to at most one of adjoining section faces 28a, b, since the intent of the invention is to have the ability to move coil sections 12a, b relative to one another as desired. An insulating interface layer 14 can be attached by any variety of methods including, but not limited to, mechanical fastening, adhesive, and/or metallurgical bonding. It is further contemplated that each section face 28a, b could carry its own insulating interface 14 so as to further prevent the mechanical wear of a given coil section 12a, b.

Once coil sections 12a, b are moved into their relative closed position, such sections 12a, b define the receiving zone boundary 30 of workpiece receiving zone 16. In the embodiment shown in FIG. 4, boundary 30 is circular in cross-section. This circular cross-section is found to be advantageous in that it tends to promote a uniform distribution of the magnetic field within zone 16. However, it is to be understood that in certain cases, especially to accommodate various workpiece shapes, it may prove useful to provide for a boundary 30 that is polygonal in cross-section.

Boundary 30 has a composite current flow associated therewith that is a product of the current path 26a, b for each coil section 12a, b proximate boundary 30. When considering the path of the individual current paths 26a, b adjacent boundary 30, a composite current flow should be unidirectional in order to achieve the appropriate degree of magnetic excitation needed in order to carry out a magnetic pulse welding or forming procedure. Essentially, the goal is to at least approximate the current flow obtained in a unitary MPW apparatus to achieve the desired magnetic pulse welding results. Specifically, the goal is to achieve substantially uniform repulsion between the coil sections 12a, b so that the workpiece (not shown) is compressed around the circumference/perimeter thereof. This desired current flow relative to boundary 30 is achievable through proper current branching and current directing within a given coil section 12a, b.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A magnetic pulse welding/forming apparatus having a open/split-coil design, said magnetic pulse welding/forming apparatus comprising:
a plurality of independent induction coil sections, each said coil section facing at least one other said coil section, said coil sections together defining a workpiece receiving zone therewithin; and
an insulating interface located between each adjacent pair of said coil sections.

2. The magnetic pulse welding/forming apparatus of claim 1, wherein said coil sections are movable relative to one another

3. The magnetic pulse welding/forming apparatus of claim 1, wherein said coil sections have independently controllable electrical power inputs.

4. The magnetic pulse welding/forming apparatus of claim 1, wherein each said coil section has a section induction current associated therewith, said coil sections thereby providing for a plurality of said section induction currents; and further wherein, when said coil sections are operatively located relative to each other, said section induction currents together form a unidirectional current flow path proximate said workpiece receiving zone.

5. The magnetic pulse welding/forming apparatus of claim 1, wherein said workpiece receiving zone has an associated cross-sectional zone shape.

6. The magnetic pulse welding/forming apparatus of claim 4, wherein said cross-sectional zone shape is circular.

7. The magnetic pulse welding/forming apparatus of claim 1, wherein a given said insulating interface layer is attached to one said coil section via at least one of mechanical fastening, adhesive bonding, and metallurgical bonding.

8. The magnetic pulse welding/forming apparatus of claim 1, wherein said coil sections are configured so as together induce a substantially uniform repulsion within a workpiece positioned within said workpiece receiving zone.

9. A magnetic pulse welding/forming apparatus having a split-coil design, said magnetic pulse welding or forming apparatus comprising:
a plurality of independent induction coil sections, each said coil section having a discharge current path, each said discharge current path having a current path direction, each said coil section facing at least one other said coil section, said coil sections together defining a workpiece receiving zone therewithin, each said coil section having a same relative said current path direction proximate said workpiece receiving zone; and
an insulating interface located between each mating pair of said coil sections.
